(19) United States
(12) Patent Application Publication
(10) Pub. No.: US 2003/0008138 A1
(43) Pub. Date: Jan. 9, 2003

(54) Protective foil for protective vehicles to be transported

(76) Inventor: Jorg Horn, Schwalmstadt (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/190,142

(22) Filed: Jul. 3, 2002

(30) Foreign Application Priority Data
Jul. 4, 2001 (DE) 101 32 242.9

(51) Int. Cl. B32B 7/12; B32B 15/04

(52) U.S. Cl. 428/343; 428/345

(57) ABSTRACT

A protective foil for covering articles such as motor vehicles during transport includes at least one protective layer and at least one adhesive layer. The adhesive layer is connected to the protective layer. The adhesive layer is made of a polymer, and it includes photo reactive UV cross-linkage initiators being substantially reactive only to radiation of wavelengths not occurring in nature. The adhesive layer is at least partly cross-linked due the photo reactive UV cross-linkage initiators being exposed to UV radiation.

### CROSS REFERENCE TO RELATED APPLICATIONS

This application claims priority to co-pending German Patent Application No. 101 32 242.9-43 entitled “Schutzfolie für den Transport von Fahrzeugen”, filed Jul. 4, 2001.

1. Fields of the Invention

The present invention generally relates to a protective foil to be used during transport of vehicles. The protective foil includes a protecting layer and a layer being made of a polymer and being connected to the protecting layer. It is common practice in the automobile industry to place a transport protection system on newly manufactured vehicles after having painted the body of the vehicle. The protection system serves to prevent the paint or the enameling of the vehicle from being damaged during transport of the vehicle from the production plant to the car dealer. Such damages may occur from the surface getting scratched or from other influences, such as rain, snow, dirt and so forth.

2. Background of the Invention

Known transport protection systems especially use waxes which are applied onto the vehicle after having applied the paint onto the vehicle. The car dealer later has to remove the layer of wax by a comparatively time consuming process. For removing the wax from the vehicle, solvents have to be used. Consequently, the car dealer also has the problem of having to care for correct waste disposal of the solvents.

From German Patent Application No. 42 23 822 A1 it is known to use an adhesive protection foil for the transport of automobiles. The known protection foil includes a protection layer and an adhesive layer, the protection layer being located on the adhesive layer. The protection foil fulfills the protection function of the vehicle during transport from the manufacturer to the dealer, and it replaces known commonly used wax layers. The protection foil with its adhesive layer contacts the paint of the vehicle, and it is desired that the adhesive layer sticks to the paint of the vehicle even during increased mechanical charges, as they, for example, occur during strong wind streams during transport of the vehicle on trucks or on trains. It is desired that the good adhesive properties are maintained, and that the protection layer reliably protects against mechanical damages and environmental influences, such as rain, snow, hail, dirt, bird excrements and the like.

The protection foil known from German Patent Application No. 42 23 822 A1 may include a plurality of adhesive layers and a plurality of protection layers. For this purpose, adhesive foils commonly known in technology are used as adhesive layers, as there are, for example, glue foils or foils being made of polymers being modified with certain functional groups. It is preferred to use acrylate glue foils or foils being made of thermoplastic polymers being modified with functional groups. Thermoplastic polymers like polyamide, polystyrole, polyester, polycarbonate or polyolefin, for example, are used as protection layers.

The protection foil known from German Patent Application No. 42 23 822 A1 including a plurality of layers is produced by the so called coating method, lamination method or the blowing/wide slot co-extrusion method. In this way, a homogeneous adhesive layer is attained without having to use solvents. The adhesive force of the protection foil on the surface of a vehicle to be attained in this known way is limited such that there is the danger of the known foil being removed from the vehicle during transport caused by winds. This disadvantage may be counteracted by using additional securing tape having strong adhesion properties. The tape is fixed in the region of the edges of the protection foil. The known protection foils may usually be easily removed from the surfaces of the vehicle, but usually parts of the glue remain located on the vehicle. The remainder of the glue has to be separately removed from the vehicle. Furthermore, at temperatures of more than approximately 70° C. (approximately 160° F.), the surface of the paint covered by the adhesive protection foil sometimes gets uneven portions.

To counteract these disadvantages, it is known from European Patent No. 0 592 913 B1 to use a copolymer of C2-C10-α-olefins and 5-80% by weight with respect to the copolymer of unsaturated, polar comonomers during transport of vehicles. Such known protection foils have the disadvantage that they tend to melt at high temperatures, and consequently the paint on the surface of the vehicle gets damaged. Such damages may also occur due to so the called cold flowing effect even at comparatively low temperatures since the chains of these thermoplastic materials are only located side by side in the layer, and there is no fixed bond between them. Such a known protection foil changes its properties in a disadvantages way especially under long term usage circumstances. The gluing force of the protection foil is not sufficient, especially at high temperatures and under great mechanical stresses, as they occur during transportation of motor vehicles being covered with the protection foil on open transport wagons of trains, for example.

According to the background of the invention of German Patent Application No. 196 35 704 A1 corresponding to U.S. Pat. No. 5,925,456, a self-adhesive foil has been known in the art, the foil consisting of a polyvinyl chloride foil including a cross-linked self-adhesive mass of polyacrylate and isocyanate. The known protection foil was used for protecting paint at the front portion of vehicles against stones and impurities due to insects during first use of the vehicle. However, there were problems since the polyacrylate mass had to be cross-linked to a great extent not to show interactions with the paint of the vehicle. Consequently, there were problems using the known foil due to insufficient adhesive effects of the foil.

According to the reaching of German Patent Application No. 196 35 704 A1, it is proposed to use a self-adhesive protection foil including a base foil on which a self-adhesive mass is located. The foil is, made of a mixture of 40% by volume up to 70% by volume of polyethylene, 20% by volume up to 40% by volume of polypropylene, 8% by volume up to 15% by volume of titan dioxide, and 0.3% by volume up to 0.7% by volume of light protection stabilizers. The self-adhesive mass consists of polyethylene vinylacetate including a share of vinylacetate of 40 mole % up to 80 mole %, and a loss angle at certain temperatures.

### SUMMARY OF THE INVENTION

The present invention relates to a protective foil for covering articles such as motor vehicles during transport. The foil includes at least one protective layer and at least one adhesive layer. The adhesive layer is connected to the protective layer. The adhesive layer is made of a polymer, and it includes photo reactive UV cross-linkage initiators being substantially reactive only to radiation of wavelengths not occurring in nature. The adhesive layer is at least partly cross-linked due the photo reactive UV cross-linkage initiators being exposed to UV radiation.

With the novel foil, it is possible to chose the adhesive layer being connected to the protective layer such that there are sufficient adhesive effects with respect to the surface of the vehicle, and with which no material of the adhesive layer remains on the painted surface of the vehicle even under long term usage conditions and at increased temperatures.

The present invention is based on the concept of designing a protection foil to include a protection layer and an adhesive layer the properties of which do not substantially change under long term using conditions and even under increased temperatures. The adhesive layer may also be called sticking layer or bonding layer. The protection foil includes an adhesive layer made of a polymer including certain portions of photo reactive cross-linking initiators. The initiators may be sensitively cross-linked by radiation. Cross-linkage may be chosen to reach different levels, as it is appropriate to attain the desired properties of the adhesive layers. Cross-linkage or cross-bondage is achieved by radiation at a wavelength which does not occur in nature. In this way, it is ensured that natural UV radiation does not continue cross-linkage effects, and consequently the properties of the adhesive layers are not changed in an undesired way. In this way, the adhesive properties of the adhesive layer may be chosen such that there is sufficient adhesiveness even during stronger mechanical stresses due to wind and the like. At the same time, it is ensured that no parts of the adhesive layer remain on the vehicle. The novel protecting foil is made of solid matter, meaning no solvents have to be used. Consequently, the novel protecting foil does not require energy consuming processes such as drying and recovering solvents, as it is the case with protection systems including solvents and with dispersions. The level of cross-linkage is defined, and it is completed during the production process.

Preferably, the protection layer made of a polymer is cross-linked in a way that its cross-linkage—and consequently cohesion of the side of the free surface of the protection layer—is more than cross-linkage and cohesion of the side of the adhesive layer facing the protection layer. The free surface of the adhesive layer is directly subjected to radiation effecting cross-linkage such that cross-linkage is realized to a greater extent than in the layers being located below the free surface layer. It is to be understood that the gradient of cross-linkage diminishes from the free surface towards the protection layer. This effect is desired to attain different gluing effects about the cross section, and especially about the surface portions. Cross-linkage may be locally chosen and adjusted, respectively, by choosing the period of time during which radiation is used and/or by choosing the concentration of the photo reactive UV inter-linkage initiators.

The adhesive layer may be made of glue which is applied onto the protective layer in melted form and without using solvents. While non-cross-linked glues being applied onto the protective layer in melted form have cold flowing properties in a disadvantageous way since the chains of applied glue even in the solid state do not remain in position (but they rather flow, especially under pulling tension), this disadvantage is counteracted by the above described cross-linkage such that cold flowing does not occur, even at increased temperatures, as it is the case in hot parts of the country. The adhesive force is reliably maintained even under such hot conditions without remainders of the glue sticking on the surface of the vehicle when removing the protection foil from the vehicle. Cross linkage has the effect of such anchoring effects of the chains of the glue with increased cohesion resulting therefrom.

Especially, the adhesive layer may be made of acrylate copolymer including the photo reactive UV cross-linkage initiators. This adhesive layer is applied to the protective layer preferably being made of polyolefins in the melted form. However, this application is a solid matter application since no solvents have to be discharged, and no solvents or water have to dry. Consequently, energy usually being necessary for this purpose is not required. The following UV cross-linkage may be realized by using mercury vapor discharge lamps. During its production, the protective foil is subjected to UV radiation of a wavelength of approximately 250 to approximately 260 nm. This radiation does not occur in nature since such radiation is filtered by the ozone layer. The natural UV radiation cannot continue the cross-linkage process, and the properties of the protective foil remain constant, even when using it for long periods of time.

The present invention also relates a protective system for protecting articles of all kinds, preferably articles made of metal. The protective system includes at least one protective layer to face away from the article to be protected and at least one adhesive layer to face the article to be protected. The adhesive layer is located on the protective layer. The adhesive layer is made of a polymer. The adhesive layer includes photo reactive UV crosslinkage initiators being substantially reactive only to radiation of wavelengths not occurring in nature. The adhesive layer is at least being cross-linked due said photo reactive UV cross-linkage initiators being exposed to UV radiation.

The present invention also relates to a method of producing a protective foil for protecting articles. The method includes the steps of producing at least one protective layer, producing at least one adhesive layer being made of a polymer and including photo reactive UV cross-linkage initiators being substantially reactive only to radiation of wavelengths not occurring in nature, connecting the adhesive layer to the protective layer, and exposing the adhesive layer and the photo reactive UV cross-linkage initiators to UV radiation not occurring in nature to at least partly attain cross-linkage.

The present invention also relates to a method of protecting an article with a protective foil. The method includes the step of applying the protective foil on the article, the protective foil including at least one protective layer to face away from the article to be protected, and at least one adhesive layer to face the article to be protected, the adhesive layer being located on the protective layer, the adhesive layer being made of a polymer, the adhesive layer including photo reactive UV cross-linkage initiators being substantially reactive only to radiation of wavelengths not occurring in nature, the adhesive layer at least being partly cross-linked due the photo reactive UV cross-linkage initiators being exposed to UV radiation.

Cross-linkage is approximately proportional to the applied energy, also meaning that it does not continue without activation. Cross-linkage begins and ends with radiation of the surface of the adhesive layer to later face the surface of the vehicle, and it continues towards the direction of the protective layer. In this way, there is a gradient of cross-linkage which leads to increased cross-linkage of the free surface of the adhesive layer to produce increased cross-linkage and increased cohesion at this side. Consequently, cold flowing effects and the effect of glue remaining on the vehicle are prevented. The more cross-linkage has been realized, the more is cohesion, and the smaller is adhesion, meaning adhesion effects with respect to the surface of the vehicle. Adhesion with respect to the surface of the vehicle is sensitively chosen such that the protective foil is not unintentionally removed during transport due to wind influences or other mechanical stresses. The desired adhesion and necessary radiation may be determined by simple tests.

Other features and advantages of the present invention will become apparent to one with skill in the art upon examination of the following detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic cross sectional view of a first exemplary embodiment of the novel protective foil.

FIG. 2 is a schematic cross sectional view of a second exemplary embodiment of the novel protective foil.

FIG. 3 is a schematic cross sectional view of a third exemplary embodiment of the novel protective foil.

### DETAILED DESCRIPTION

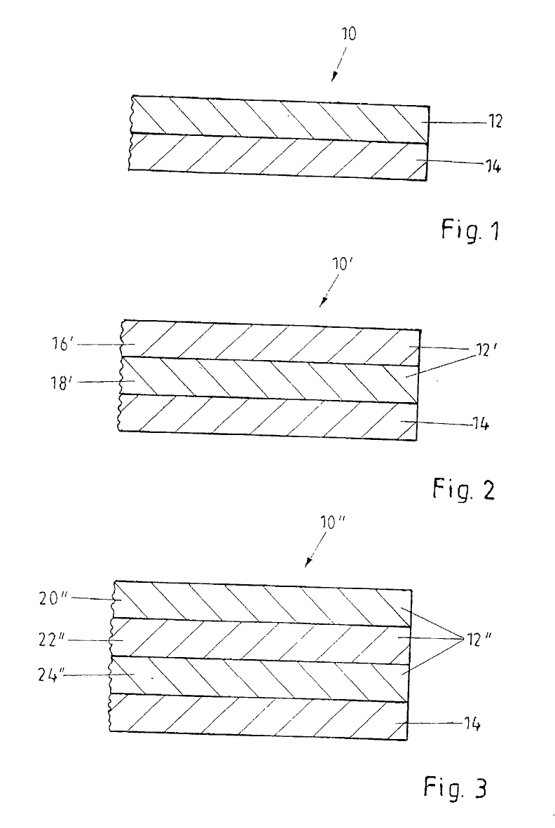

Referring now in greater detail to the drawings, FIG. 1 schematically illustrates the novel protective foil 10 including at a protective layer 12 and an adhesive layer 14 being connected to the protective layer 12. Usually, one first produces the protective layer 12 to then connect the adhesive layer 14 to the protective layer 12 to attain the novel protective foil 10 to be used for the protection of articles, especially for cars during their transport from the plant to the car dealer.

FIG. 2 schematically illustrates a second exemplary embodiment of the novel protective foil 10′ in which the protective layer 12 ′ includes two layers 16′ and 18′. The layer 16′ facing away from the vehicle (not shown) and from the adhesive layer 14 is made of modified polypropylene, while the other layer 18′ facing the adhesive layer 14 is made of modified polypropylene mixed with a copolymer of the ethyl vinyl acetate group.

FIG. 3 schematically illustrates another exemplary embodiment of the novel protective foil 10″ in which the protective layer 12″ includes three layers 20″, 22″ and 24″. The two outer layers 20″ and 24″ are made of modified polypropylene. The layer 22″ is a mixture of LLDPE and copolymer of vinyl acetate glue.

FIGS. 1-3 only show the schematic design of the layers without indicating their thickness. Many variations and modifications may be made to the preferred embodiments of the invention without departing substantially from the spirit and principles of the invention. All such modifications and variations are intended to be included herein within the scope of the present invention, as defined by the following claims.

### DETAILED DESCRIPTION OF PREFERRED EMBODIMENTS

The novel protective foil includes at least one protective layer and at least one adhesive layer being connected to the protective layer. Usually, one first produces the protective layer to then connect the adhesive layer to the protective layer to attain the novel protective foil to be used for the protection of vehicles, especially cars, during their transport from the plant to the car dealer.

In a first exemplary embodiment, the novel protecting foil includes a protective layer being designed as a polyolefin foil including a three layer design. The two outer layers are made of modified polypropylene. Polypropylene is chosen because of its greater resistance against heat compared to polyethylene, and due to its comparatively flat surface. The flat and even surface of the outer surface facing away from the adhesive layer allows for natural release properties. These release properties are required for simple handling of the protecting foil during unwinding it from a reservoir coil. The middle layer is a mixture of LLDPE and copolymer of vinyl acetate glue. The middle layer provides great cohesion of the two outer layers made of modified polypropylene, and due to its great splice resistance, it reduces the tension of the outer surfaces made of modified polypropylene to be teared. The first exemplary embodiment of the protective foil has a total thickness of approximately 50 μm. The outer surface of the protective layer which later faces away from the vehicle is wide pigmented and UV stabilized to counteract brittleness and mechanical reduction of the properties of the protective layer during permanent use under the influence of radiation by the sun. Due to wide pigmentation, reflection of UV radiation is an additional effect. UV stabilization is limited to keep the UV stabilizers usually migrating low. All migrating material, as UV stabilizers, and especially slip additives have to be precisely watched and dosed. This first exemplary embodiment of the novel foil does not use slip additives at all to prevent changes of the gluing force of the adhesive layer.

A second exemplary embodiment of the novel protective layer includes two layers. The protective layer facing away from the vehicle and from the adhesive layer is made of modified polypropylene, while the other layer facing the adhesive layer is made of modified polypropylene mixed with a copolymer of the ethyl vinyl acetate group. This mixture serves to realize especially good adhesive effects acting between the protective layer and the adhesive layer. The adhesive effects acting between the protective layer and the adhesive layer may be further improved by intense so called corona treatment of the protective layer at the side of the adhesive material.

The purpose of the second adhesive layer being located between the first adhesive layer and the protective layer is to prevent portions of the first adhesive layer from remaining on the article to be protected—meaning the painted sheet metal of the vehicle., In this second exemplary embodiment, adhesion acting between the adhesive layer and the protective layer is sufficient.

However, there is a second possible problem due to which erroneous properties of the protective foil may be caused. The second possible problem is the so called cohesion break. A cohesion break is to be understood as a break occurring inside the adhesive layer when the molecular chains of the polymer material are capable of being displaced under thermal or mechanical stresses. Such cohesion breaks are prevented by the novel cross-linkage effects of the novel protective foil.

The above described exemplary embodiments of the novel protective layer have been used in combination with various exemplary adhesive layers. In the above described two exemplary embodiments, the thickness of the adhesive layer has been chosen to be approximately 2 g/m2 and approximately 5 g/m2, respectively. The adhesive layer is made of acrylate copolymer reacting to UW light, including no solvents and having a density of more than approximately 1 g/m3. The UV reactive groups are not physically mixed, but they are rather polymerized. In this way, a bond to the molecular chains has been reached such that volatile components do not migrate, and there are no negative effects to the production and application in an uncontrolled way. The adhesive layer is applied at processing temperatures of between approximately 120° C. (approximately 250° F.) and 140° C. (approximately 290° F.). The general adhesiveness of the adhesive layer being made of a polymer is modified by adding resins, especially partially hydrated, esterified colophonium resins and terpene phenolic resins.

Properties and features of adhesion and cohesion acting inside the adhesive layer and between the adhesive layer and the protective layer are substantially influenced by the thickness of the adhesive layer applied to the protective layer. An increase of the thickness of the adhesive layer results in an increase of adhesiveness. Cross-linkage counteracts this effect. A great degree of cross-linkage reduces adhesiveness.

Especially, mercury average pressure radiators are used to cross-link the adhesive layers. However, it is also possible to use UJV radiators being excited by microwaves. Depending on what kind of radiators are used, different removing velocities of the protective foil and respective cross-linkage intensities are realized. Production velocity and cross-linkage intensity are to be coordinated. Generally, it is not necessary to work under inert gas atmosphere conditions during the process of cross-linking. However, it is preferred to realize direct contact of the radiation serving to attain cross-linkage on the adhesive layer. In this way, different levels of cross-linkage are realized inside the adhesive layer. An increased level of cross-linkage results in the outer portions of the adhesive layer, whereas there is less cross-linkage in the inner portions of the adhesive layer. The portions of the adhesive layer which directly contact the protective layer have a comparatively low degree of cross-linkage, and they consequently have increased adhesion. This condition is desired to guarantee better adhesion of the adhesive layer on the protective layer due to increased adhesion.

Preferably, the adhesive layer is applied on the already produced protective layer. The application may be realized in melted form, and it is desired to uniformly distribute it such that the protective layer is uniformly covered with the adhesive layer material. The melted adhesive layer is heated in a reservoir container, and it is applied onto the protective layer in the form a flat melted billet. It is preferred to apply the adhesive layer to the protective layer as even and uniform as possible. It is preferred to allow for film forming effects. Since the protective layer preferably is made of polyolefins, and it therefore is sensitive to heat, a nozzle by which the material of the adhesive layer is applied may not directly contact the protective layer, and it may not be located too close since the adhesive material has a temperature of between approximately 120° C. (approximately 250° F.) and 140° C. (approximately 290° F.). It is preferred to realize a distance between the nozzle and the protective layer of a plurality of millimeters.

Many variations and modifications may be made to the preferred embodiments of the invention without departing substantially from the spirit and principles of the invention. All such modifications and variations are intended to be included herein within the scope of the present invention, as defined by the following claims.

1. A protective foil for covering vehicles during transport, comprising:
at least one protective layer; and
at least one adhesive layer,
said adhesive layer being connected to said protective layer,
said adhesive layer being made of a polymer,
said adhesive layer including photo reactive UV cross-linkage initiators being substantially reactive only to radiation of wavelengths not occurring in nature,
said adhesive layer at least being partly cross-linked due said photo reactive UV cross-linkage initiators being exposed to UV radiation.

2. The protective foil of claim 1, wherein said adhesive layer is cross-linked in a way that cross-linkage of said adhesive layer and cohesion at the side of the free surface of said adhesive layer is more than cross-linkage and cohesion at the side of said adhesive layer facing said protective layer.

3. The protective foil of claim 1, wherein said adhesive layer is cross-linked in a way that adhesion of said adhesive layer with respect to said protective layer is more than adhesion of said protective layer at the side of the free surface of said adhesive layer.

4. The protective foil of claim 2, wherein said adhesive layer is cross-linked in a way that adhesion of said adhesive layer with respect to said protective layer is more than adhesion of said protective layer at the side of the free surface of said adhesive layer.

5. The protective foil of claim 1, wherein said adhesive layer is made of glue, said glue as a melted mass being applied onto said protective layer.

6. The protective foil of claim 2, wherein said adhesive layer is made of glue, said glue as a melted mass being applied onto said protective layer.

7. The protective foil of claim 3, wherein said adhesive layer is made of glue, said glue as a melted mass being applied onto said protective layer.

8. The protective foil of claim 4, wherein said adhesive layer is made of glue, said glue as a melted mass being applied onto said protective layer.

9. The protective foil of claim 1, wherein said adhesive layer is made of acrylate copolymer including said photo reactive UV cross-linkage initiators.

10. The protective foil of claim 1, wherein said protective layer is made of polyolefins.

11. The protective foil of claim 1, wherein said protective foil during its production is exposed to UV radiation of a wavelength of approximately 250 nanometer to approximately 260 nanometers.

12. The protective foil of claim 1, wherein said adhesive layer is completely cross-linked.

13. A protective system for protecting articles, comprising:
at least one protective layer to face away from the article to be protected; and
at least one adhesive layer to face the article to be protected,
said adhesive layer being located on said protective layer,
said adhesive layer being made of a polymer,
said adhesive layer including photo reactive UV cross-linkage initiators being substantially reactive only to radiation of wavelengths not occurring in nature,
said adhesive layer at least being partly cross-linked due said photo reactive UV cross-linkage initiators being exposed to UV radiation.

14. The protective system of claim 13, wherein said adhesive layer is cross-linked in a way that cross-linkage of said adhesive layer and cohesion at the side of the free surface of said adhesive layer is more than cross-linkage and cohesion at the side of said adhesive layer facing said protective layer.

15. The protective system of claim 13, wherein said adhesive layer is cross-linked in a way that adhesion of said adhesive layer with respect to said protective layer is more than adhesion of said protective layer at the side of the free surface of said adhesive layer.

16. The protective system of claim 13, wherein said adhesive layer is made of acrylate copolymer including said photo reactive UV cross-linkage initiators.

17. The protective system of claim 13, wherein said protective layer is made of polyolefins.

18. The protective foil of claim 13, wherein said protective system is a foil which during its production is exposed to UV radiation of a wavelength of approximately 250 nanometer to approximately 260 nanometers.

19. A method of producing a protective foil for protecting articles, said method comprising the steps of:
producing at least one protective layer;
producing at least one adhesive layer being made of a polymer and including photo reactive UV cross-linkage initiators being substantially reactive only to radiation of wavelengths not occurring in nature;
connecting the adhesive layer to said protective layer; and
exposing the adhesive layer and said photo reactive UV cross-linkage initiators to UV radiation not occurring in nature to at least partly attain cross-linkage.

20. The method of claim 19, wherein said step of connecting the adhesive layer to the protective layer includes applying melted glue to the protective layer.

21. The method of claim 19, wherein the adhesive layer is made of acrylate copolymer including the photo reactive UV cross-linkage initiators.

22. The method of claim 19, wherein the protective layer is made of polyolefins.

23. The method of claim 19, wherein in the step of exposing the adhesive layer and the photo reactive UV cross-linkage initiators to UV radiation a wavelength of approximately 250 nanometers to approximately 260 nanometers is used.

24. A method of protecting an article with a protective foil, said method comprising the step of:
applying the protective foil on the article, the protective foil including at least one protective layer to face away from the article to be protected, and at least one adhesive layer to face the article to be protected, the adhesive layer being located on the protective layer, the adhesive layer being made of a polymer, the adhesive layer including photo reactive UV cross-linkage initiators being substantially reactive only to radiation of wavelengths not occurring in nature, the adhesive layer at least being partly cross-linked due the photo reactive UV cross-linkage initiators being exposed to UV radiation.

25. The method of claim 24, wherein the article is a motor vehicle to be transported from the production plant to the car dealer.
